(19) United States
(12) Patent Application Publication
(10) Pub. No.: US 2004/0013200 A1
(43) Pub. Date: Jan. 22, 2004

(54) Advanced method of coding and decoding motion vector and apparatus therefor

(75) Inventor: Byung-cheol Song, Gyeonggi-do (KR)

Correspondence Address: STAAS & HALSEY LLP, SUITE 700, 1201 NEW YORK AVENUE, N.W., WASHINGTON, DC, 20005, US

(73) Assignee: SAMSUNG Electronics Co., Ltd. of Republic of Korea

(21) Appl. No.: 10/435,670

(22) Filed: May 12, 2003

(30) Foreign Application Priority Data
Jul. 18, 2002 (KR) 2002-41986

(51) Int. Cl. H04N 7/12

(52) U.S. Cl. 375/240.16; 375/240.23

(57) ABSTRACT

A method and apparatus code and decode a motion vector. The method includes calculating a motion vector difference between a motion vector of a current block and a motion vector of a reference block and performing run-length coding on the motion vector difference in predetermined group units having at least one macro block.

### CROSS-REFERENCE TO RELATED APPLICATIONS

This application claims the benefit of Korean Patent Application No. 2002-41986, filed on Jul. 18, 2002, in the Korean Intellectual Property Office, the disclosure of which is incorporated herein by reference.

### BACKGROUND OF THE INVENTION

1. Field of the Invention

The present invention relates to a method and apparatus for coding a moving image, and more particularly, to a method and apparatus for efficiently coding and decoding a motion vector in a moving image compression technique based on motion compensation.

2. Description of the Related Art

Moving image compression standards, such as Moving Picture Experts Group (MPEG) and H.26x, employ a compression method based on motion compensation and conversion. In such a coding method based on motion compensation, motion vector information of each block must be coded before transmission. When Common Intermediate Format (CIF) or Quarter-CIF (QCIF) images are coded at a low transmission rate, the amount of motion vector information is usually greater than 30%, so compression efficiency largely depends on a method of compressing a motion vector.

FIG. 1 is a block diagram of a general encoder 100 for coding a moving image. For Video On Demand (VOD) services or moving image communication, the encoder 100 generates a bitstream coded using a compression technique and outputs the generated bitstream.

A Discrete Cosine Transform (DCT) section 110 performs a DCT operation on image data input in units of 8×8 pixel blocks, in order to remove spatial correlation. The quantization (Q) section 120 quantizes DCT coefficients obtained in the DCT section 110 to represent them with several representative values. Consequently, efficient loss compression can be accomplished.

An inverse quantization (IQ) section 130 inverse quantizes the quantized image data received from the Q section 120. An Inverse Discrete Cosine Transform (IDCT) section 140 performs IDCT on the inverse-quantized image data received from the IQ section 130. A frame memory section 150 stores the image data subjected to IDCT in the IDCT section 140 in frame units.

A motion estimation (ME) section 160 calculates a motion vector (MV) in each macro block using image data of a currently input frame and image data of a previous frame stored in the frame memory section 150. A variable length coding (VLC) section 170 codes the MV received from the ME section 160 so that statistical redundancy can be removed.

When a current macro block is determined as being coded in an inter mode, an MV of the current macro block must be transmitted to a decoder. Here, as shown in FIGS. 2A through 2D, the horizontal and vertical components of the MV of the current macro block are obtained by performing differential coding using one among the MVs of three neighboring macro blocks.

In addition, U.S. Pat. No. 6,122,321 discloses an encoder similar to the general encoder 100 shown in FIG. 1.

FIGS. 2A through 2D are diagrams for explaining an MV prediction scheme defined in an MPEG-4 specification and a prediction scheme for the edge of a frame. The following description concerns an MV prediction scheme defined in the MPEG-4 specification.

In FIGS. 2A through 2D, MV is an MV of a current macro block, and its three neighboring MVs, i.e., MV1, MV2, and MV3, are candidate predictors for differential coding. MV1 is an MV of a previous macro block, MV2 is an MV of an above macro block, and MV3 is an MV of an above right macro block. Dotted lines indicate a border of a frame, for example, a video object plane (VOP) defined in the MPEG-4, including the current macro block. The following rules are applied to macro blocks at the edge of a current frame.

1. As shown in FIG. 2B, when a single macro block having a candidate predictor is positioned outside the current frame, the candidate predictor of the macro block is set to (0, 0).

2. As shown in FIG. 2C, when two macro blocks having a candidate predictor are positioned outside the current frame, the candidate predictors of the respective macro blocks are set to the same value as a candidate predictor of a macro block within the current frame.

3. As shown in FIG. 2D, when all macro blocks having a candidate predictor are positioned outside the current frame, the candidate predictors of the respective macro blocks are set to (0, 0).

When a single MV is transmitted per macro block, as shown in FIG. 2, a predictor for a current macro block is determined using MVs of neighboring macro blocks, i.e., candidate predictors, and then a difference between the determined predictor and the MV of the current macro block is transmitted.

Hereinafter, a method of calculating a predictor value will be described with reference to FIGS. 2A through 2D.

Referring to FIGS. 2A through 2D, a predictor value corresponding to the MV of a current macro block is a median of the neighboring MVs, i.e., MV1, MV2, and MV3. In addition, MV coding is independently performed on the horizontal and vertical components of the MV. Accordingly, medians for the respective horizontal and vertical components of the MV are separately calculated using Formulas (1) and (2).

Pₓ=Median(MV1ₓ,MV2ₓ,MV3ₓ) (1)

P_{y}=Median(MV1_{y},MV2_{y},MV3_{y}) (2)

For example, when MV1=(−2, 3), MV2=(1, 5), and MV3=(−1, 7), Pₓ=−1 and P_{y}=5 according to Formulas (1) and (2).

In the meantime, when an error_resilient_disable_flag is not set in the MPEG-2 and the MPEG-4, prediction in one direction is performed using Formulas (3) and (4).

Pₓ=MV1ₓ (3)

P_{y}=MV1_{y} (4)

Here, if a resynchronization marker is generated, immediately the MV1 is set to (0, 0).

MV differences MVDₓ and MVD_{y} for the respective components of the MV are calculated according to Formulas (5) and (6) using the medians, i.e. predictor values, Pₓ and P_{y} calculated according to Formulas (1) and (2) or the predictor values Pₓ and P_{y} calculated according to Formulas (3) and (4).

MVDₓ=MVₓ−Pₓ (5)

MVD_{y}=MV_{y}−P_{y} (6)

Each of the MV differences is converted into a bitstream not having statistical redundancy, using a variable length coder. Here, codes used for performing VLC on the MV differences MVDₓ and MVD_{y} are a little different, depending on standards.

However, in conventional technology, even though the MV differences MVDₓ and MVD_{y} have a value of 0 in many images, one bit must be transmitted as information on each of the MV differences MVDₓ and MVD_{y} because every process for MV coding is performed in units of macro blocks. Accordingly, the conventional technology has the disadvantage of generating unnecessary MV information on a frame having no motion or having a uniform MV field.

### SUMMARY OF THE INVENTION

The present invention provides an advanced method of coding a motion vector and an apparatus therefore, by which motion vector coding efficiency can be increased.

The present invention also provides an advanced method of decoding a motion vector and an apparatus therefor, by which motion vector coding and decoding efficiency are increased.

According to an aspect of the present invention, a method codes a motion vector by calculating a motion vector difference between a motion vector of a current block and a motion vector of a reference block, and performing run-length coding on the calculated motion vector difference in predetermined group units comprising at least one macro block.

Generally, the predetermined group unit is one selected from the group consisting of a single macro block, a half slice, a single slice, a plurality of slices, and a single frame.

Typically, the method may further include performing variable length coding on a vector (run, length) indicating a run-length coded motion vector difference.

In addition, the method may further include inserting coding unit information, which indicates the predetermined group unit for the run-length coding, into the coded result.

According to another aspect of the present invention, a method codes a motion vector by calculating a motion vector difference between a motion vector of a current block and a motion vector of a reference block, performing run-length coding on the calculated motion vector difference in first group units comprising at least one macro block, and performing run-length coding on the calculated motion vector difference in second group units comprising at least one macro block.

The method may further include performing variable length coding on a vector (run, length) indicating a run-length coded motion vector difference obtained using a variable length coding table formed in first group units; and performing variable length coding on a vector (run, length) indicating a run-length coded motion vector difference obtained using a variable length coding table formed in second group units.

Typically, the first and second group units are each a single macro block, a half slice, a single slice, a plurality of slices, or a single frame, and the first group unit is different from the second group unit.

The method may further include comparing an amount of data in a motion vector bitstream resulting from the first-group unit coding with an amount of data in a motion vector bitstream resulting from the second-group unit coding to select the motion vector bitstream having less data, and inserting coding unit information indicating a coding unit used for the selected motion vector bitstream into the selected motion vector bitstream.

According to still another aspect of the present invention, a method decodes a coded motion vector bitstream by performing variable length decoding on an input motion vector bitstream in predetermined coding units, performing run-length decoding on the variable length decoded motion vector bitstream in the predetermined coding units, calculating a motion vector difference between a motion vector of a current block and a motion vector of a reference block from run-length decoded data and calculating the motion vector of the current block using the calculated motion vector difference.

Generally, the coding unit is a single macro block, a half slice, a single slice, a plurality of slices, or a single frame.

Typically, performing variable length decoding on an input motion vector bitstream in predetermined coding units includes detecting the coding unit used for the input motion vector bitstream from coding unit information included in the input motion vector bitstream, and performing variable length decoding on the input motion vector bitstream using a variable length decoding table formed in the detected coding units.

According to still another aspect of the present invention, an apparatus to code a motion vector includes a motion vector difference calculation unit, which calculates a motion vector difference between a motion vector of a current block and a motion vector of a reference block; and a run-length coding unit, which performs run-length coding on the motion vector difference calculated by the motion vector difference calculation unit in predetermined group units comprising at least one macro block.

According to still another aspect of the present invention, an apparatus to code a motion vector includes a motion vector difference calculation unit, which calculates a motion vector difference between a motion vector of a current block and a motion vector of a reference block; a first run-length coding unit, which performs run-length coding on the motion vector difference calculated by the motion vector difference calculation unit, in first group units comprising at least one macro block; and a second run-length coding unit, which performs run-length coding on the motion vector difference calculated by the motion vector difference calculation unit, in second group units comprising at least one macro block.

According to still another aspect of the present invention, an apparatus to decode a coded motion vector bitstream includes a variable length decoding unit, which performs variable length decoding on an input motion vector bitstream in predetermined coding units; a run-length decoding unit, which performs run-length decoding on the variable length decoded motion vector bitstream output from the variable length decoding unit in the predetermined coding units; and a motion vector difference calculation unit, which calculates a motion vector difference between a motion vector of a current block and a motion vector of a reference block from run-length decoded data output from the run-length decoding unit.

Additional aspects and advantages of the invention will be set forth in part in the description which follows and, in part, will be obvious from the description, or may be learned by practice of the invention.

### BRIEF DESCRIPTION OF THE DRAWINGS

These and/or other and advantages of the invention will become apparent and more readily appreciated from the following description of the preferred embodiments taken in conjunction with the accompanying drawings in which:

FIG. 1 is a block diagram of a general encoder to code a moving image;

FIGS. 2A through 2D are diagrams illustrating a motion vector (MV) prediction method performed by an MV encoder in accordance with an embodiment of the present invention;

FIG. 3 is a diagram of an apparatus to code an MV according to a first embodiment of the present invention;

FIG. 4 is a diagram of an apparatus to code an MV according to a second embodiment of the present invention;

FIG. 5 is a diagram of an apparatus to decode an MV according to the first embodiment of the present invention;

FIG. 6 is a flowchart of a method of coding an MV according to the first embodiment of the present invention;

FIG. 7 is a flowchart of a method of coding an MV according to the second embodiment of the present invention; and

FIG. 8 is a flowchart of a method of decoding a coded MV bitstream according to the first embodiment of the present invention.

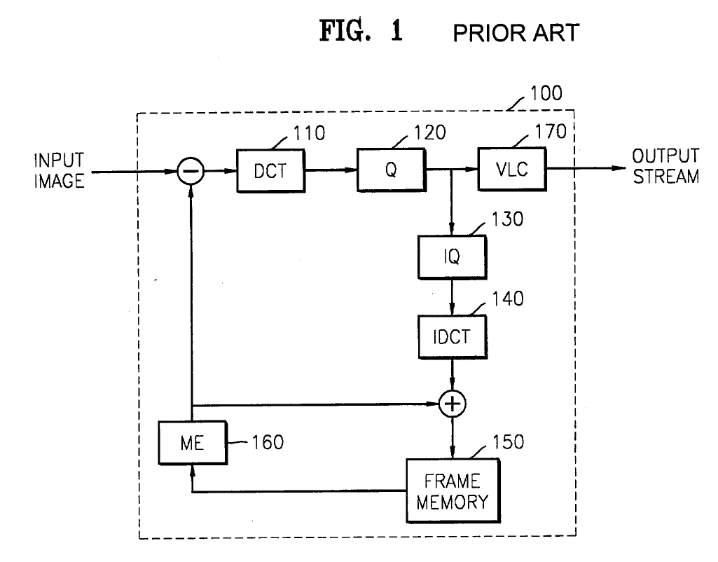

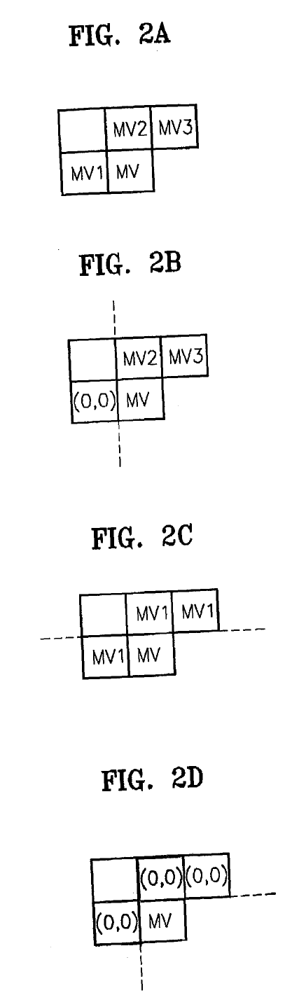

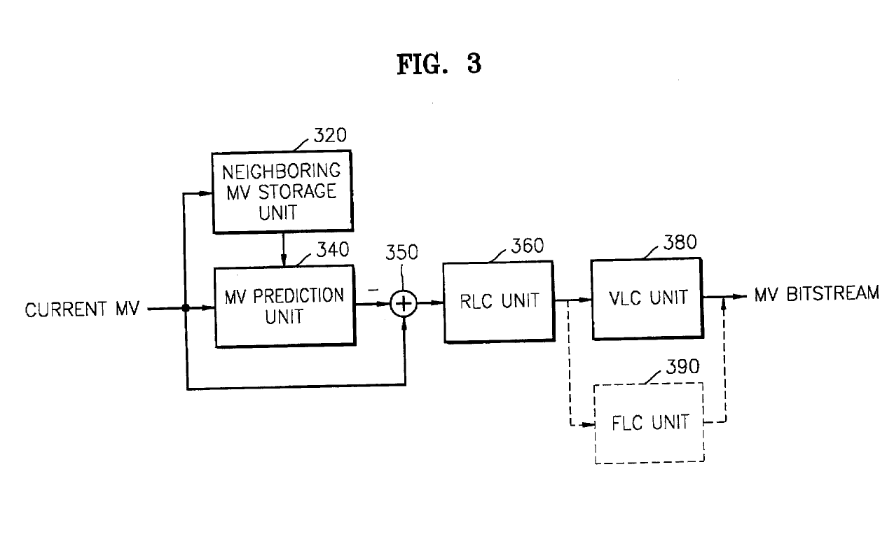

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to the like elements throughout. The embodiments are described below in order to explain the present invention by referring to the figures.

Hereinafter, embodiments of the present invention are described in detail with reference to the attached drawings.

FIG. 3 is a diagram of an apparatus to code a motion vector (MV) according to a first embodiment of the present invention. The apparatus to code an MV includes a neighboring MV storage unit 320 storing information on the MVs of blocks neighboring a current block; a MV prediction unit 340, which detects a predictor for the MV of the current block using the neighboring MV information stored in the neighboring MV storage unit 320; an MV difference (MVD) calculation unit 350, which calculates an MVD, i.e., a difference between the predictor detected by the MV prediction unit 340 and the MV of the current block; a run-length coding (RLC) unit 360, which performs RLC on the calculated MVD in predetermined units, for example, in slice units or in frame units; and a variable length coding (VLC) unit 380, which performs VLC on the output of the RLC unit 360.

Hereinafter, operation of the apparatus to code an MV according to the first embodiment of the present invention is described with reference to FIG. 3.

Generally, MVs have a strong correlation to the neighboring MVs and form a uniform MV field. Accordingly, in many cases, predictors calculated using Formulas (1) through (4) are the same as the MV of a current block, that is, MVDₓ=0 (or MVD_{y}=0). In addition, MVDs consecutively have a value of 0 in many cases. The present invention is based on such characteristics.

According to the first embodiment of the present invention, the MV prediction unit 340 calculates predictors Pₓ and P_{y} using the neighboring MV information stored in the neighboring MV storage unit 320 and Formulas (1) and (2) based on a median filtering method. However, the predictors Pₓ and P_{y} may be calculated using Formulas (3) and (4).

The MVD calculation unit 350 calculates MVDs using current MV information and the predictors Pₓ and P_{y} obtained by the MV prediction unit 340.

The RLC unit 360 performs RLC on MVDs calculated by the MVD calculation unit 350 in selected group units, i.e., slice units or frame units, in the first embodiment. For example, when the size of a current frame is 352×288, and all macro blocks are processed in an inter mode, RLC is performed on 396 MVDs at one time, i.e., in frame units, or 22 MVDs at one time, i.e., in slice units. Alternatively, RLC can be performed in units of other groups having a different size than the above-described units and including at least one macro block, for example, in ½ slice units or in units of groups including at least one slice.

In the first embodiment of the present invention, the RLC unit 360 performs two-dimensional RLC, generates and outputs a set of (run, length). Here, the “run” indicates the number of zeros before a non-zero MVD, and the “length” indicates the size of the non-zero MVD.

Alternatively, the RLC unit 360 may use three-dimensional RLC. In this case, the RLC unit 360 generates and outputs a set of (last, run, length). The “last” is 1-bit information indicating whether a current MVD is the last non-zero MVD.

The VLC unit 380 performs VLC on the vector (run, length) output from the RLC unit 360. In the first embodiment, VLC is performed on a vector (run, length). However, fixed length coding (FLC) may be performed on the “run” of the vector (run, length) using an FLC unit 390, and VLC may be performed on the “length” using the VLC unit 380.

Selectively, coding unit information indicating a coding unit may be inserted into an output MV bitstream using a coding unit information insertion unit (not shown).

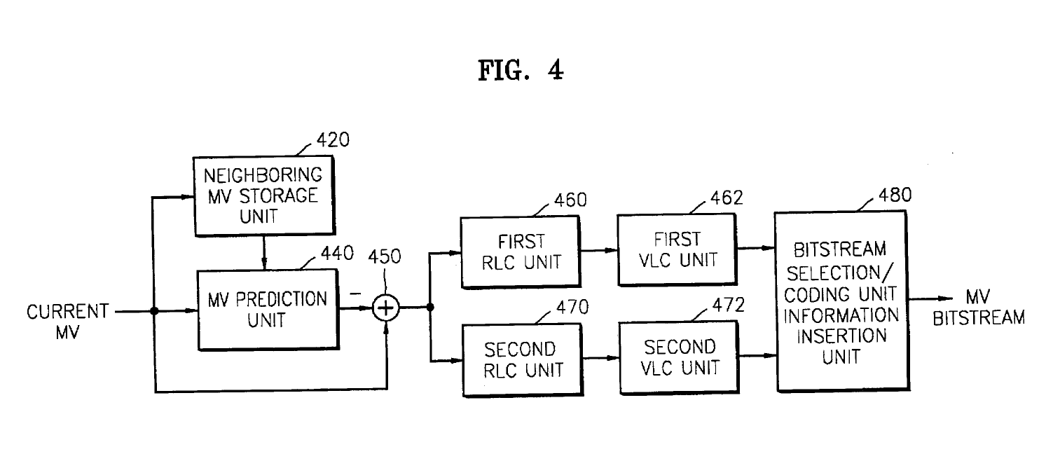

FIG. 4 is a diagram of an apparatus to code an MV according to a second embodiment of the present invention. Referring to FIG. 4, the apparatus to code an MV includes a neighboring MV storage unit 420 storing information on the MVs of blocks neighboring a current block; a MV prediction unit 440, which detects a predictor for the MV of the current block using the neighboring MV information stored in the neighboring MV storage unit 420; an MVD calculation unit 450, which calculates an MVD, i.e., a difference between the predictor detected by the MV prediction unit 440 and the MV of the current block; a first RLC unit 460, which performs RLC on the calculated MVD in first group units; a second RLC unit 470, which performs RLC on the calculated MVD in second group units; a first VLC unit 462, which performs VLC on the output of the first RLC unit 460 based on a first group unit VLC table; a second VLC unit 472, which performs VLC on the output of the second RLC unit 470 based on a second group unit VLC table; and a bitstream selection/coding unit information insertion unit 480, which selects a single MV bitstream from MV bitstreams received from the first and second VLC coding units 462 and 472 and inserts coding unit information of the selected MV bitstream into the selected MV bitstream.

The neighboring MV storage unit 420, the MV prediction unit 440, the MVD calculation unit 450, the first and second RLC units 460 and 470, and the first and second VLC units 462 and 472 of the apparatus for coding an MV shown in FIG. 4 perform the same functions as the corresponding functional units of the apparatus shown in FIG. 3, and thus detailed descriptions thereof will be omitted.

The bitstream selection/coding unit information insertion unit 480 compares the amount of bits in the MV bitstream received from the first VLC unit 462 with the amount of bits in the MV bitstream received from the second VLC unit 472 in units of frames, selects the MV bitstream having fewer bits, and inserts coding unit information, which indicates a coding unit during the RLC and VLC of the selected MV bitstream, into the selected MV bitstream.

For example, where the first group unit is a frame and the second group unit is a slice, when an MV bitstream output from the first VLC unit 462 is selected as a finally output MV bitstream as the result of comparing the amount of data of an MV bitstream output from the first VLC 462 with the amount of data of an MV bitstream output from the second VLC 472 with respect to a single frame, coding unit information indicating that the coding unit used in the first RLC unit 460 and the first VLC unit 462 was a frame is inserted into the selected MV bitstream.

In the second embodiment of the present invention, the coding unit information is set per frame and uses a flag of one bit. However, the coding unit information may be set per a different predetermined group and may use a flag having the different predetermined number of bits.

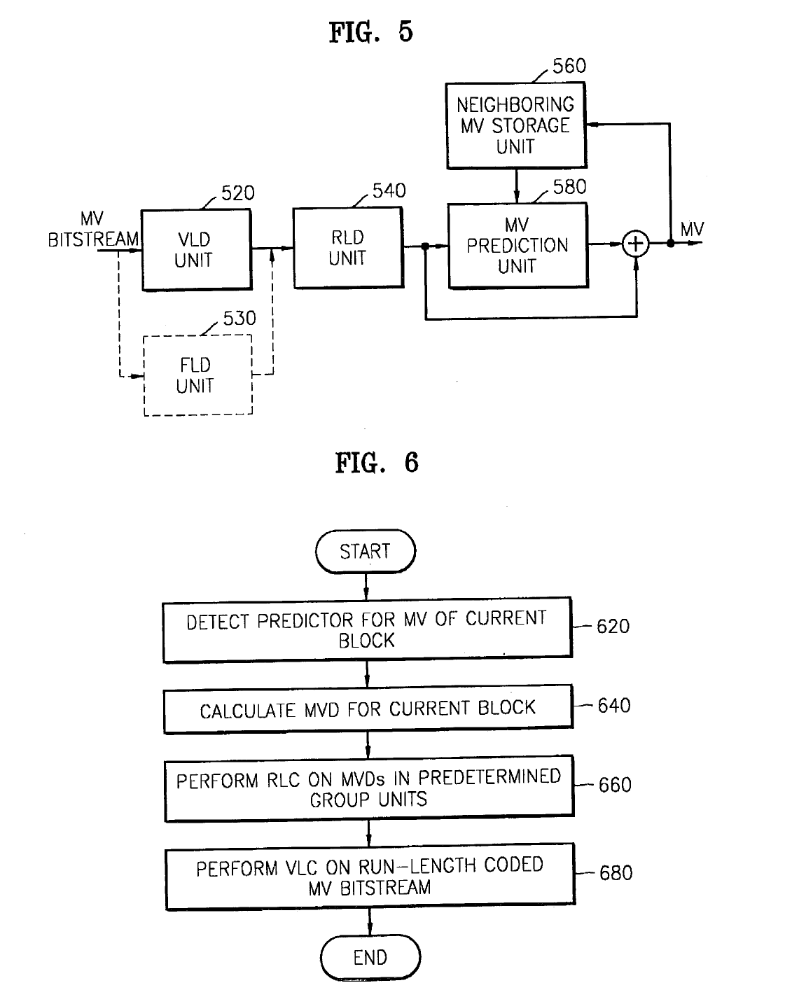

FIG. 5 is a diagram of an apparatus to decode an MV according to the first embodiment of the present invention. The apparatus to decode an MV includes a variable length decoding (VLD) unit 520 performing VLD on an input MV bitstream to generate a vector (run, length), and a run-length decoding (RLD) unit 540 performing RLD on the vector (run, length) generated from the VLD unit 520 to generate an MVD. The apparatus restores an MV in units of macro blocks using the MVD generated from the RLD 540 and MV information stored in a neighboring MV storage unit 560.

When necessary, for example, when FLC has been performed on the “run” of the vector (run, length) during encoding, a fixed length decoding (FLD) unit 530 may be used to perform FLD on the “run” of the vector (run, length).

FIG. 6 is a flowchart of a method of coding an MV according to the first embodiment of the present invention. The method of coding an MV according to the first embodiment is described with reference to FIGS. 3 and 6.

A predictor for an MV of a current block is detected using MV information of blocks neighboring the current block in operation 620. In the first embodiment of the present invention, the MV prediction unit 340 calculates predictors Pₓ and P_{y} using the MV information of blocks neighboring the current block stored in the neighboring MV storage unit 320 and Formulas (1) and (2) based on a median filtering method. However, the predictors Pₓ and Pₓ may be calculated using Formulas (3) and (4).

A difference, i.e., an MVD, between the detected predictor and MV information of the current block is calculated in operation 640. In the first embodiment of the present invention, the MVD calculation unit 350 calculates MVDs using the current MV information and the predictors Pₓ and P_{y} obtained by the MV prediction unit 340.

RLC is performed on the MVDs calculated in operation 640 in predetermined group units, for example, in slice units, in operation 660. In the first embodiment of the present invention, RLC is performed on the MVDs in slice units. However, RLC may be performed in frame units or in units of other groups having a predetermined size.

VLC is performed on a run-length coded MV bitstream obtained in operation 660, in step 680.

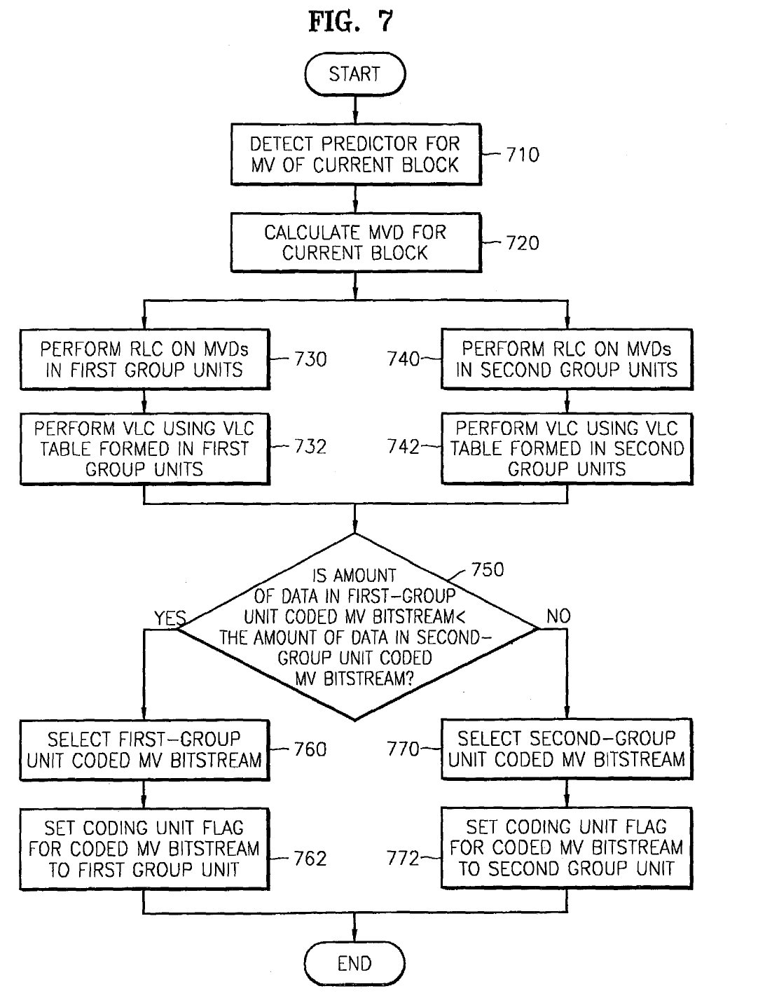

FIG. 7 is a flowchart of a method of coding an MV according to the second embodiment of the present invention. The method of coding an MV according to the second embodiment is described with reference to FIGS. 4 and 7.

A predictor for an MV of a current block is detected using MV information of blocks neighboring the current block in operation 710. In the second embodiment of the present invention, the MV prediction unit 440 calculates predictors Pₓ and P_{y} using the MV information of blocks neighboring the current block stored in the neighboring MV storage unit 420 and Formulas (1) and (2) based on a median filtering method. However, the predictors Pₓ and Pₓ can be calculated using Formulas (3) and (4).

A difference, i.e., an MVD, between the detected predictor and MV information of the current block is calculated in operation 720. In the second embodiment of the present invention, the MVD calculation unit 450 calculates MVDs using the current MV information and the predictors Pₓ and P_{y} obtained by the MV prediction unit 440.

RLC is performed on the MVDs calculated in operation 720 in first group units in operation 730. VLC is performed on a run-length coded MV bitstream obtained in operation 730, using a VLC table formed in the second group units, in operation 732.

RLC is performed on the MVDs calculated in operation 720 in second group units in operation 740. VLC is performed on a run-length coded MV bitstream obtained in operation 740, using a VLC table formed in the first group units in operation 742.

The amount of data in an MV bitstream obtained by performing VLC in the first group units in operation 732 is compared with the amount of data in an MV bitstream obtained by performing VLC in the second group units in operation 742, in operation 750. If the amount of data in the first-group unit coded MV bitstream is less than the amount of data in the second-group unit coded MV bitstream, the method progresses to operation 760. If the amount of data in the second-group unit coded MV bitstream is less than the amount of data in the first-group unit coded MV bitstream, the method progresses to operation 770.

The MV bitstream obtained in operation 732 is selected in operation 760. Then, coding unit information indicating that a coding unit is the first group unit is inserted into the selected MV bitstream in operation 762.

The MV bitstream obtained in operation 742 is selected in operation 770. Then, coding unit information indicating that a coding unit is the second group unit is inserted into the selected MV bitstream in operation 772.

In the first embodiment of the present invention, the amounts of data in the respective MV bitstreams are compared with each other in frame units in operation 750. However, the comparison may be performed in different predetermined group units, for example, in slice units or in units of groups including at least two slices.

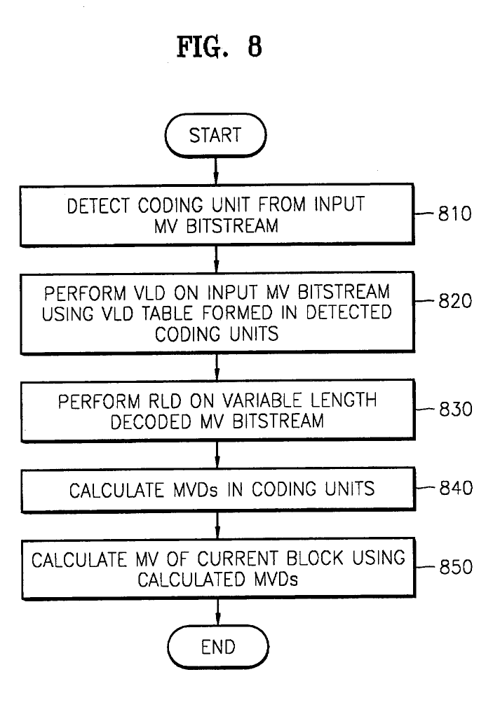

FIG. 8 is a flowchart of a method of decoding a coded MV bitstream according to the first embodiment of the present invention. Referring to FIG. 8, a coding unit is detected from coding unit information included in an input MV bitstream in operation 810.

VLD is performed on the input MV bitstream using a VLD table formed in the detected coding units in operation 820. In the first embodiment of the present invention, the coding unit is a frame or slice. However, the coding unit may be a predetermined group comprising at least one macro block.

RLD is performed on the variable length decoded MV bitstream in operation 830. MVDs between an MV of a current block and an MV of a reference block are calculated from the run-length decoded MV bitstream in the coding units in operation 840. The MV of the current block is calculated using the calculated MVDs in operation 850.

In the embodiments of the present invention, MV coding is performed in predetermined group units, for example, in frame or slice units. However, by adding a selection mode to a coded bitstream, coding may be adaptively performed in macro block units, considering the result of performing RLC and VLC on an image in frame or slice units, for example, considering the amount of bits generated in frame or slice units.

The present invention may be realized as a code which is recorded on a computer readable recording medium and may be read by a computer. The computer readable recording medium may be any type on which data which may be read by a computer system may be recorded, for example, a ROM, a RAM, a CD-ROM, a magnetic tape, a hard disc, a floppy disc, a flash memory, or an optical data storage device. The present invention may also be realized as carrier waves (for example, transmitted through the Internet). Alternatively, computer readable recording media may be distributed among computer systems connected through a network so that the present invention may be realized as a code which is stored in the recording media and may be read and executed in the computers.

As described above, in the present invention, RLC is performed on MVs in predetermined units using spatial correlation between MVs, and then VLC is performed, so that MV coding efficiency may be increased. As a result, a compression rate of a moving image coding apparatus may be increased.

The present invention is not limited to the above-described embodiments. It will be understood by those skilled in the art that various changes may be made in the embodiments without departing from the spirit and scope of the invention defined by the appended claims.

Also, the present invention may be implemented by using computer-executable instructions stored on a computer-readable medium.

Although a few preferred embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A method of coding a motion vector, comprising:
calculating a motion vector difference between a motion vector of a current block and a motion vector of a reference block; and
performing run-length coding on the motion vector difference in predetermined group units comprising at least one macro block.

2. The method of claim 1, wherein the predetermined group units include one selected from the group consisting of a single macro block, a half slice, a single slice, a plurality of slices, and a single frame.

3. The method of claim 1, further comprising performing variable length coding on a vector (run, length) indicating a run-length coded motion vector difference.

4. The method of claim 1, further comprising performing fixed length coding on a “run” of a vector (run, length) indicating a run-length coded motion vector difference and variable length coding on the “length”.

5. The method of claim 3, further comprising inserting coding unit information, which indicates the predetermined group unit for the run-length coding, into the coded result.

6. A method of coding a motion vector, comprising:
calculating a motion vector difference between a motion vector of a current block and a motion vector of a reference block;
performing run-length coding on the motion vector difference in first group units comprising at least one macro block; and
performing run-length coding on the motion vector difference in second group units comprising at least one macro block.

7. The method of claim 6, further comprising:
performing variable length coding on a vector (run, length) indicating a run-length coded motion vector difference obtained using a variable length coding table formed in first group units; and
performing variable length coding on a vector (run, length) indicating a run-length coded motion vector difference obtained using a variable length coding table formed in second group units.

8. The method of claim 6, further comprising:
performing fixed length coding on a “run” of a vector (run, length) indicating a run-length coded motion vector difference and variable length coding on the “length” using a variable length coding table formed in first group units; and
performing fixed length coding on a “run” of a vector (run, length) indicating a run-length coded motion vector difference and variable length coding on the “length” using a variable length coding table formed in second group units.

9. The method of claim 6, wherein the first and second group units are each one selected from the group consisting of a single macro block, a half slice, a single slice, a plurality of slices, and a single frame, and the first group unit is different from the second group unit.

10. The method of claim 7, further comprising comparing an amount of data in a motion vector bitstream resulting from the first-group unit coding performed with an amount of data in a motion vector bitstream resulting from the second-group unit coding performed to select the motion vector bitstream having less data.

11. The method of claim 10, further comprising inserting, into the motion vector bitstream, coding unit information indicating a coding unit used for the motion vector bitstream.

12. A method of decoding a coded motion vector bitstream, comprising:
performing variable length decoding on an input motion vector bitstream in predetermined coding units to provide a variable length decoded motion vector bitstream;
performing run-length decoding on the variable length decoded motion vector bitstream in the predetermined coding units to provide run-length decoded data;
calculating a motion vector difference between a motion vector of a current block and a motion vector of a reference block from the run-length decoded data; and
calculating a coded motion vector of the current block using the motion vector difference.

13. The method of claim 12, wherein a coding unit of the predetermined coding units is one selected from the group consisting of a single macro block, a half slice, a single slice, a plurality of slices, and a single frame.

14. The method of claim 12, wherein performing variable length decoding on an input motion vector bitstream in predetermined coding units comprises:
detecting the coding unit used for the input motion vector bitstream from coding unit information included in the input motion vector bitstream; and
performing variable length decoding on the input motion vector bitstream using a variable length decoding table formed in the detected coding units.

15. An apparatus to code a motion vector, comprising:
a motion vector difference calculation unit, which calculates a motion vector difference between a motion vector of a current block and a motion vector of a reference block; and
a run-length coding unit, coupled to the motion vector difference calculation unit, which performs run-length coding on the motion vector difference calculated by the motion vector difference calculation unit in predetermined group units comprising at least one macro block.

16. The apparatus of claim 15, wherein the predetermined group units include one selected from the group consisting of a single macro block, a half slice, a single slice, a plurality of slices, and a single frame.

17. The apparatus of claim 15, further comprising a variable length coding unit coupled to the run-length coding unit, which performs variable length coding on a vector (run, length) indicating a run-length coded motion vector difference obtained by the run-length coding unit.

18. The apparatus of claim 15, further comprising a fixed length and variable length coding unit coupled to the run-length coding unit, which performs fixed length coding on a “run” of a vector (run, length) indicating a run-length coded motion vector difference obtained by the run-length coding unit and variable length coding on the “length”.

19. The apparatus of claim 17, wherein the apparatus inserts coding unit information, which indicates the predetermined group unit for the run-length coding performed by the run-length coding unit, into the coded result.

20. An apparatus to code a motion vector, comprising:
a motion vector difference calculation unit, which calculates a motion vector difference between a motion vector of a current block and a motion vector of a reference block;
a first run-length coding unit coupled to the motion vector difference calculation unit, which performs run-length coding on the motion vector difference calculated by the motion vector difference calculation unit, in first group units comprising at least one macro block; and
a second run-length coding unit coupled to the motion vector difference calculating unit, which performs run-length coding on the motion vector difference calculated by the motion vector difference calculation unit, in second group units having at least one macro block.

21. The apparatus of claim 20, further comprising:
a first variable length coding unit coupled to the first run-length coding unit, which performs variable length coding on a vector (run, length) indicating a run-length coded motion vector difference obtained by the first run-length coding unit, using a variable length coding table formed in first group units; and
a second variable length coding unit, coupled to the second run-length coding unit, which performs variable length coding on a vector (run, length) indicating a run-length coded motion vector difference obtained by the second run-length coding unit, using a variable length coding table formed in second group units.

22. The apparatus of claim 20, further comprising:
a first variable length coding unit coupled to the first run-length coding unit, which performs fixed length coding on a “run” of a vector (run, length) indicating a first-group unit run-length coded motion vector difference obtained by the first run-length coding unit and variable length coding on the “length” using a variable length coding table formed in first group units; and
a second variable length coding unit, coupled to the second run-length coding unit, which performs fixed length coding on a “run” of a vector (run, length) indicating a second-group unit run-length coded motion vector difference obtained by the second run-length coding unit and variable length coding on the “length” using a variable length coding table formed in second group units.

23. The apparatus of claim 20, wherein the first and second group units are each one selected from the group consisting of a single macro block, a half slice, a single slice, a plurality of slices, and a single frame, and the first group unit is different from the second group unit.

24. The apparatus of claim 21, further comprising an optimal motion vector bitstream selection unit coupled to the first and second variable length coding units, which compares a first amount of data in a motion vector bitstream resulting from the first-group unit coding performed by the first variable length coding unit with a second amount of data in a motion vector bitstream resulting from the second-group unit coding performed by the second variable length coding unit to select the motion vector bitstream having less data.

25. The apparatus of claim 24, wherein the optimal motion vector bitstream selection unit inserts, into the motion vector bitstream, coding unit information indicating a coding unit used for the motion vector bitstream.

26. An apparatus to decode a coded motion vector bitstream, comprising:
a variable length decoding unit, which performs variable length decoding on an input motion vector bitstream in predetermined coding units to provide a variable length decoded motion vector bitstream;
a run-length decoding unit coupled to the variable length coding unit, which performs run-length decoding on the variable length decoded motion vector bitstream to provide run-length decoded data; and
a motion vector difference calculation unit coupled to the run-length decoding unit, which calculates a motion vector difference between the motion vector of the current block and a motion vector of a reference block from the run-length decoded data.

27. The apparatus of claim 26, wherein the coding unit is one selected from the group consisting of a single macro block, a half slice, a single slice, a plurality of slices, and a single frame.

28. The apparatus of claim 26, wherein the variable length decoding unit detects the coding unit used for the input motion vector bitstream from coding unit information included in the input motion vector bitstream, and performs variable length decoding on the input motion vector bitstream using a variable length decoding table formed in the detected coding units.

29. The method of claim 4, further comprising inserting coding unit information, which indicates the predetermined group unit for the run-length coding, into the coded result.

30. A computer-readable medium having stored thereon computer-executable instructions for coding a motion vector, the computer-executable instructions comprising:
calculating a motion vector difference between a motion vector of a current block and a motion vector of a reference block; and
performing run-length coding on the motion vector difference in predetermined group units comprising at least one macro block.

31. A computer-readable medium having stored thereon computer-executable instructions for coding a motion vector, the computer-executable instructions comprising:
calculating a motion vector difference between a motion vector of a current block and a motion vector of a reference block;
performing run-length coding on the motion vector difference in first group units comprising at least one macro block; and
performing run-length coding on the motion vector difference in second group units comprising at least one macro block.

32. A computer-readable medium having stored thereon computer-executable instructions to decode a coded motion vector bitstream, the computer-readable instructions comprising:
performing variable length decoding on an input motion vector bitstream in predetermined coding units to provide a variable length decoded motion vector bitstream;
performing run-length decoding on the variable length decoded motion vector bitstream in the predetermined coding units to provide run-length decoded data;
calculating a motion vector difference between a motion vector of a current block and a motion vector of a reference block from the run-length decoded data; and
calculating a coded motion vector of the current block using the motion vector difference.
